(19) United States
(12) Patent Application Publication
(10) Pub. No.: US 2024/0382372 A1
(43) Pub. Date: Nov. 21, 2024

(54) MASSAGER

(71) Applicant: Jianbin Zhou, Ji'an City (CN)

(72) Inventor: Jianbin Zhou, Ji'an City (CN)

(21) Appl. No.: 18/786,413

(22) Filed: Jul. 26, 2024

(30) Foreign Application Priority Data
Jun. 21, 2024 (CN) 202421437173.5

(51) Int. Cl. A61H 19/00; A61H 23/02

(52) U.S. Cl. CPC A61H 19/44; A61H 23/0218; A61H 23/0254; A61H 2201/0153; A61H 2201/123

(57) ABSTRACT

The present invention discloses a massager designed by the present invention, an accommodation cavity includes an actuation zone, two opposite walls of the actuation zone are respectively flexible walls, an actuator is mounted in the accommodation cavity, and located between the two opposite flexible walls, and includes a moving part and a linear motion driver, the linear motion driver is used for driving the moving part to make reciprocating linear motion along an axis of the actuation zone so as to act on an inner side of at least one flexible wall, and enable an outer side of the at least flexible wall to be in a raised bulging state.

### TECHNICAL FIELD

The present invention belongs to the technical field of massage care, and particularly relates to a massager.

### BACKGROUND

A massager is widely used for various parts and organs of a human body, and has different structures and different use effects for different users. There are various types of existing massagers, such as a manual beating massager and a negative pressure massager, where the negative pressure massager uses an air pump for air extraction to generate negative pressure for massaging, but large noise is easy to cause during operation of the air pump. The manual beating massager is suitable for low-frequency beating, and a hand is laborious when the massager is used for fast beating for a long time, whereby a new massager is urgently needed to replace them.

### SUMMARY

In order to solve at least one of the above technical problems, the present invention provides a massager.

The massager designed in the present invention includes:
a housing internally provided with an actuation zone, two opposite side walls located at the actuation zone on the housing are respectively flexible walls; and
an actuator mounted in the actuation zone, the actuator is located between the two opposite flexible walls, and the flexible walls on the housing are driven by the actuator to move, where the actuator includes a moving part and a linear motion driver, the moving part is magnetically coupled to the linear motion driver, whereby the linear motion driver drives the moving part to make reciprocating linear motion along an axis of the actuation zone, to drive the flexible walls to make reciprocating motion.

The massager of the present invention has the following beneficial effects:
1. the moving part is driven by magnetic coupling of an electromagnetic coil, whereby the massager generates less noise during use, improves the use effect, and besides, can achieve fast beating.
2. The linear reciprocating motion of the moving part is used to act on the flexible walls, whereby the outer sides of the flexible walls are repeatedly raised and reset to perform beating massage on human skin.

### BRIEF DESCRIPTION OF THE DRAWINGS

FIG. 1 shows a sectional view of an overall structure;

FIG. 2 shows a partial view (I);

FIG. 3 shows a partial view (II);

FIG. 4 shows an exploded view (I) of an overall structure;

FIG. 5 shows a sectional view (II) of an overall structure;

FIG. 6 shows a sectional view (III) of an overall structure;

FIG. 7 shows a schematic diagram of an overall structure; and

FIG. 8 shows a schematic diagram of a partial structure of a massager provided with a hollow part.

### REFERENCE NUMERALS

1. hard shell; 11. accommodation cavity; 111. actuation zone; 112. second through hole; 113. third half groove; 12. side limiting body; 121. mounting cavity; 122. second limiting plate; 123. second half groove; 13. upper limiting body; 131. first through hole; 132. first limiting plate; 133. half groove; 14. lower limiting body; 2. flexible shell; 21. flexible wall; 211. convex part; 212. circular concave and convex ripple; 213. convex ripple; 214. concave ripple; 215. hollow part; 3. actuator; 31. linear motion driver; 311. insulation framework; 312. electromagnetic coil; 313. moving channel; 314. convex ring; 33. push rod; 331. concave part; 332. step; 4. flexible sheet; 5. battery; 6. vibration motor; 7. control panel.

### DESCRIPTION OF THE EMBODIMENTS

In order that those skilled in the art better understand the present invention to define the claimed scope of the invention more clearly, the present invention is described below in detail with reference to some particular embodiments of the invention. It should be noted that the following description only refers to some particular embodiments within the inventive concept, which are only part of the embodiments of the invention, where the detailed direct description of the related structures is only for the convenience of understanding the invention, and various specific features do not certainly and directly define the implementation range of the present invention.

### Embodiment I

A massager of the embodiment includes a housing 100 and an actuator 3 arranged in the housing 100, where the housing 100 includes a hard shell 1, an accommodation cavity 11 is formed in the hard shell 1, an actuation zone 111 is arranged on the accommodation cavity 11, two opposite walls of the actuation zone 111 are respectively flexible walls 21, and the actuator 3 is mounted in the accommodation cavity 11, and is located between the two opposite flexible walls 21; the actuator 3 includes a moving part 32 and a linear motion driver 31, where the moving part 32 is connected to or abutted against or spaced apart from the flexible walls 21; when the moving part 32 and the flexible walls 21 are connected, the moving part 32 and the flexible walls 21 are separate components and are fixedly connected, or are integrally formed members; when the moving part 32 is abutted against the flexible walls 21, two ends of the moving part 32 are respectively abutted against an inner side of each flexible wall 21; and when the moving part 32 is spaced apart from the flexible walls 21, a gap between the moving part 32 and the flexible walls 21 is smaller than a reciprocating moving stroke of the moving part 32.

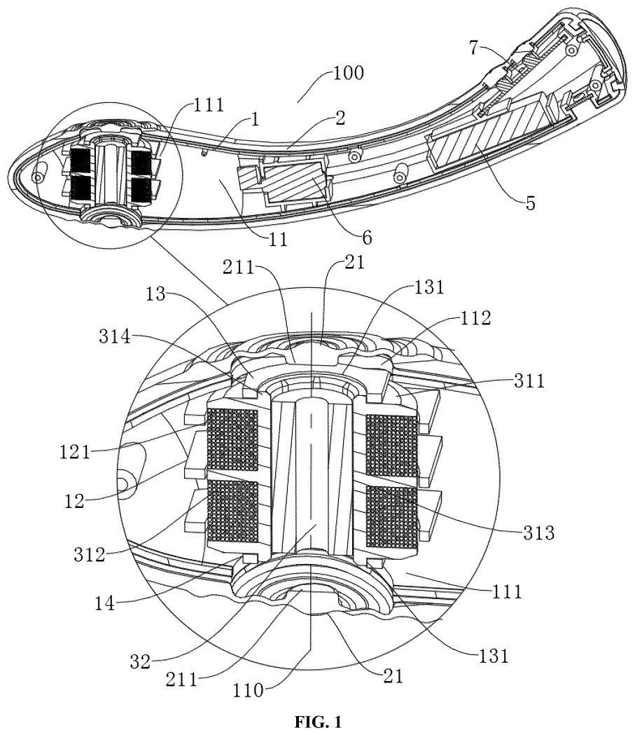

As shown in FIG. 1, the moving part 32 is made of a magnetic material, and the linear motion driver 31 includes an insulation framework 311 and an electromagnetic coil 312 wound on an outer wall of the insulation framework 311; the insulation framework 311 is provided with a moving channel 313, and the moving part 32 is placed in the moving channel 313; a battery 5 is further arranged in the accommodation cavity 11, and the battery 5 and the electromagnetic coil 312 are connected with a master control chip on a control panel 7 in the accommodation cavity 11; the master control chip generally uses an MCU chip, a current direction switching program and an output current increasing or decreasing program are set in the master control chip, and a current direction switches to change the direction of current transmitted to the electromagnetic coil 312, so the direction of the current constantly changes, and the direction of a magnetic field generated by the electromagnetic coil 312 also constantly changes to drive the moving part 32 to make reciprocating linear motion. An output current increases or decreases to control the speed of the reciprocating motion of the moving part, and when the current increases, the flexible walls 21 make rapid reciprocating motion.

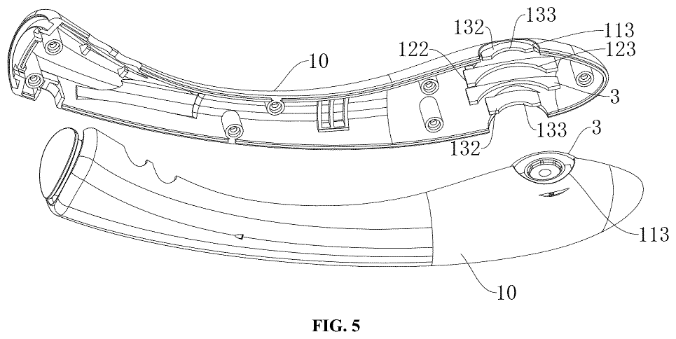

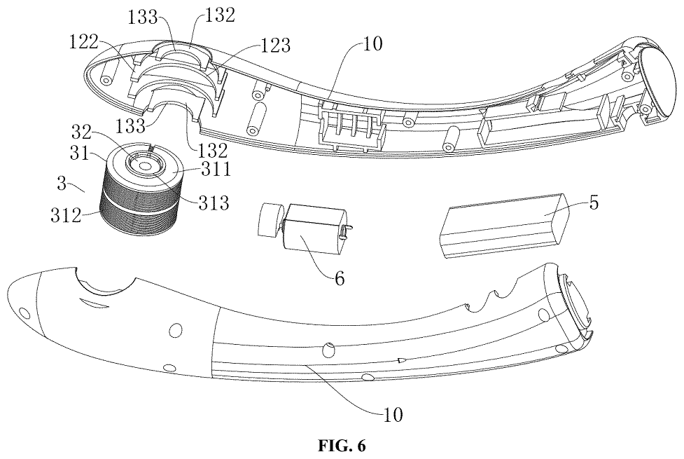

Further, as shown in FIGS. 1, 5 and 6, a side limiting body 12, an upper limiting body 13 and a lower limiting body 14 are arranged on an inner wall of the actuation zone 111 of the accommodation cavity 11, a mounting cavity 121 is formed in the side limiting body 12, the linear motion driver 31 is mounted in the mounting cavity 121, and the upper limiting body 13 and the lower limiting body 14 are respectively located at an upper port and a lower port of the mounting cavity 121, whereby the upper limiting body 13 and the lower limiting body 14 respectively limit an upper end and a lower end of the linear motion driver 31; and first through holes 131 which are coaxially formed with a moving channel 313 are respectively formed in the upper limiting body 13 and the lower limiting body 14, a diameter of each first through hole 131 is greater than or equal to that of the moving channel 313, two second through holes 112 respectively corresponding to positions of the first through holes 131 are formed in the hard shell, and the flexible walls 21 are respectively arranged at positions on an outer side of the hard shell to correspondingly cover positions of the two second through holes 112. A convex ring 314 is arranged at the port of the moving channel 313 and is matched in the first through hole 131 to be in a gap fit with each other. Its structural setting can enable the linear motion driver 31 to be mounted reliably and stably.

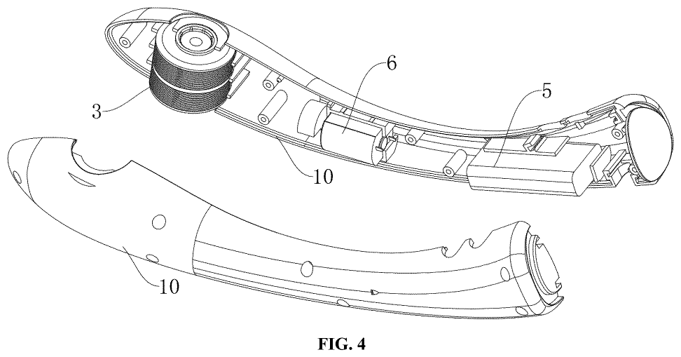

Preferably, as shown in FIGS. 4-6, the hard shell 1 is formed by two symmetrically spliced and connected half shells 10, and the two half shells are connected by screws. The upper limiting body 13 and the lower limiting body 14 both include two first limiting plates 132 respectively arranged on inner walls of the two half shells; after the two first limiting plates 132 are symmetrically spliced mutually, first half grooves 133 of the two first limiting plates 132 are spliced mutually to form the first through hole 131, and the side limiting body 12 includes two limiting groups respectively arranged on the inner walls of the two half shells; after the two limiting groups are symmetrically spliced, half cavities in the two limiting groups are mutually spliced to form the mounting cavity 121; each limiting group consists of a plurality of second limiting plates 122 which are mutually arranged in parallel and spaced apart; the second half groove 123 in each second limiting plate 122 of each limiting group forms the half cavity; third half grooves 113 are respectively formed in two opposite sides of the actuation zone on each half shell, and the two third half grooves 113 in each position are symmetrically spliced to form the second through hole 112; and the structural setting is convenient for mounting of internal parts, and the hard shell is made of plastic.

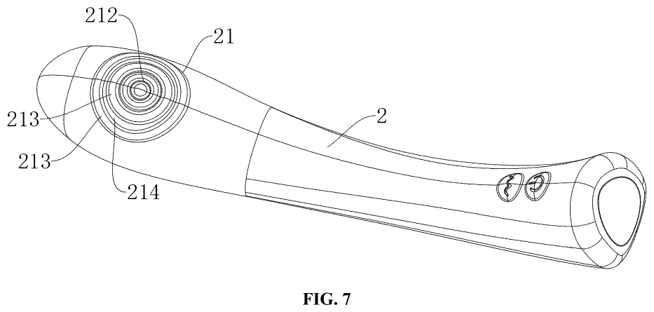

Preferably, as shown in FIGS. 1 and 7, the housing 100 further includes a flexible shell 2 wrapping the outer wall of the hard shell, and the two flexible walls 21 are formed on the flexible shell 2. The setting of the flexible shell makes a hand-held part and a massage part of the hard shell flexible, whereby a user feels more comfortable when hand-holding the massager, and feels more comfortable when the massager is in contact with parts of a human body during massage, and the flexible shell 2 is made of silicone.

At least one flexible wall 21 is in a raised state or a flat state before being applied with the pushing and pressing force by the moving part 32. Specifically, one flexible wall 21 is generally in a raised state, and the other flexible wall 21 is in a flat state. However, the two flexible walls 21 can be in a flat state or the raised state, whereby this setting can be selected according to actual situations.

The master control chip changes the direction of the current transmitted to the electromagnetic coil 312 by using the current direction switching program in the master control chip after being electrified for operating, so the direction of the current constantly changes, and the direction of a magnetic field generated by the electromagnetic coil 312 also constantly changes, whereby the moving part 32 is driven to make reciprocating linear motion along an actuation axis 110 of the actuation zone 111 to apply the pushing and pressing force to an inner side of one flexible wall 21, and the outer side of the corresponding flexible wall 21 is in a raised bulging state; while the pushing and pressing force is not applied to the inner side of the other flexible wall 21, whereby the other flexible wall 21 keeps its original state; and a raised bulging area on the outer side of the flexible wall 21 is used for massaging, whereby the human skin is massaged under rapid bulging and resetting reciprocating motion of the flexible wall 21.

In the embodiment, as shown in FIGS. 1 and 7, the flexible wall 21 is provided with a corrugated connecting wall 212 which is arranged along the moving part 32 as its center, whereby the corrugated connecting wall 212 can be on the outer surface and/or the inner surface of the flexible wall 21; and furthermore, a concave ripple 214 is formed between two adjacent convex ripples 213 in the corrugated connecting wall 212, and the convex ripple 213 and the concave ripple 214 are both arranged in a circular shape, whereby the structure enables elastic performance of the flexible walls to be improved to facilitate bulging of the flexible walls. Alternatively, the flexible walls 21 can be in the second through holes 112 and connected with the hard shell 1, and outer edges of the flexible walls 21 can be connected or integrally bonded to inner walls of the second through holes 112.

In the embodiment, as shown in FIG. 1, the convex part 211 is formed on the inner side of the flexible wall 21 and is arranged at the center of the corrugated connecting wall 212, and the position of the convex part 211 corresponds to that of the moving part 32. Generally, the convex parts 211 are respectively arranged at the centers on the inner sides of the two flexible walls 21, whereby the moving part 32 directly applies the pushing and pressing force onto the convex part 211 to realize that the outer sides of the flexible walls 21 can be more easily in a raised bulging state.

In the embodiment, a vibration motor 6 is embedded and fixed in the mounting groove in the accommodation cavity 11, the vibration motor 6 is connected to the master control chip, and the master control chip controls the start and stop of the vibration motor 6, thereby realizing that the massager also has a vibration massage function.

### Embodiment II

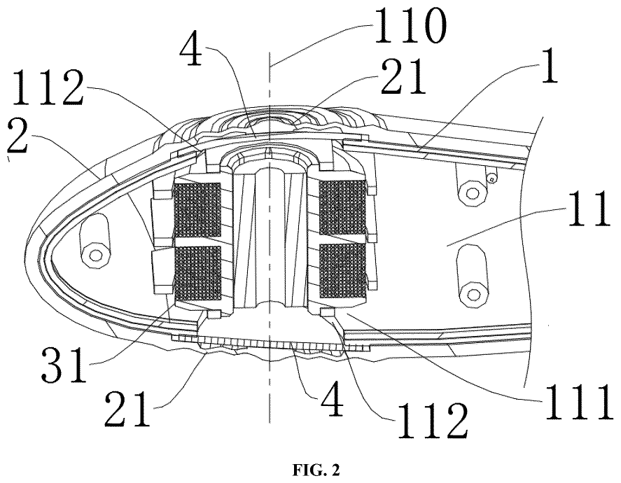

A massager of the embodiment has a general structure similar to that of embodiment I, but differs from embodiment I in that: as shown in FIG. 2, flexible sheets 4 are arranged on an inner side of each flexible wall 21, an edge of each flexible sheet 4 is at least partially connected to an inner side of a wall on an actuation zone 111, that is all edges of the flexible sheets 4 are connected to the inner side of the wall on the actuation zone 111, or a part of the edges of the flexible sheets 4 are connected to the inner side of the wall on the actuation zone 111. Herein, the number of the flexible sheets 4 can be set as two, and each flexible sheet 4 is located between a second through hole 112 and the flexible wall 21 at each position, and the edges of the flexible sheets 4 are respectively clamped between the inner side of a flexible shell 2 located at the edges of the flexible walls 21 at each position and the outer side of a hard shell located at the outer port of the second through hole 112. The edges of the flexible sheets 4 are glued to the outer side of the hard shell and to the inner wall of the flexible shell 2, respectively.

The master control chip changes the direction of the current transmitted to the electromagnetic coil 312 by using the current direction switching program in the master control chip after being electrified for operating, so the direction of the current constantly changes, and the direction of a magnetic field generated by the electromagnetic coil 312 also constantly changes, whereby a moving part 32 is driven to make reciprocating linear motion along an actuation axis 110 of the actuation zone 111 to apply the pushing and pressing force to an inner side of the flexible sheet 4 of one flexible wall 21, the flexible wall 21 and the corresponding flexible sheet 4 expand outward synchronously, and the outer side of the corresponding flexible wall 21 at this position is in a raised bulging state; while the pushing and pressing force is not applied to the inner side of the flexible wall 21 at the other flexible wall 21, whereby the other flexible wall 21 and the flexible sheet 4 keep original states, and the raised bulging area on the outer side of the flexible wall 21 is used for massaging.

Preferably, the flexible sheet 4 is made of a silicone material.

Furthermore, the flexible sheet 4 is in a gap fit or contact fit with a convex part 211. While in gap fit, the gap between the flexible sheet and the convex part is small, and the flexible sheet and the convex part are almost close to each other, therefore, after the flexible sheet is applied with the pushing and pressing force, the outer side of the flexible wall can be raised by pushing and pressing the flexible wall with the flexible sheet and the convex part 211.

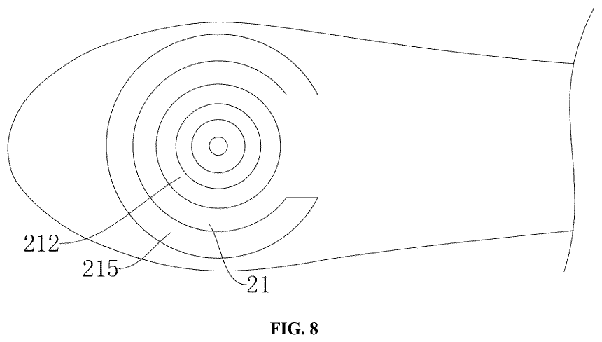

In another implementation, as shown in FIG. 8, at least one flexible wall 21 is provided with a hollow part, and the hollow part is arranged around an edge of the flexible wall 21.

### Embodiment III

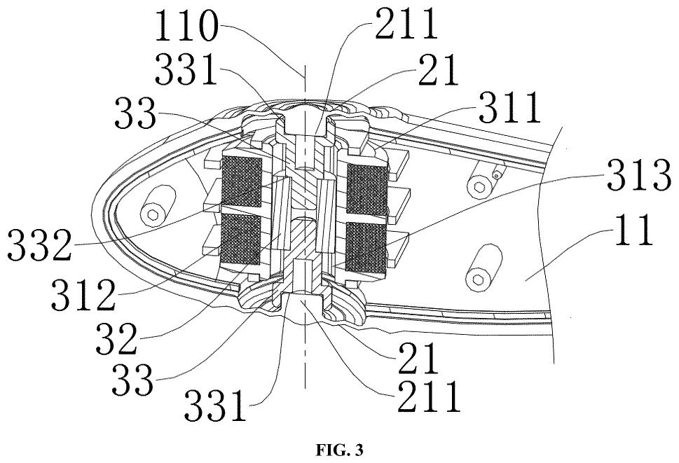

A massager of the embodiment has a general structure similar to that of embodiment I or embodiment II, but differs from embodiment I and embodiment II in that: as shown in FIG. 3, a moving part 32 is abutted against or connected to flexible walls 21, at least one end of the moving part 32 is mounted with push rods 33, and an end part of the at least one push rod 33 is abutted against or connected to the corresponding flexible wall 21; while in use, a master control chip changes the direction of the current transmitted to the electromagnetic coil 312 by using a current direction switching program in the master control chip after being electrified for operating, so the direction of the current constantly changes, and the direction of a magnetic field generated by the electromagnetic coil 312 also constantly changes, whereby the moving part 32 and the push rods 33 are driven to make reciprocating linear motion along an actuation axis 110 of an actuation zone 111, whereby pushing and pressing force is applied to an inner side of one flexible wall 21 by the push rod 33, and the outer side of the corresponding flexible wall 21 is in the raised bulging state; while the pushing and pressing force is not applied to the inner side of the other flexible wall 21, whereby the outer side of the other flexible wall 21 is in the original state or the recessed state, where the raised bulging area on the outer side of the flexible wall 21 is used for massaging.

Further, a convex part 211 is formed on an outer side of the at least one flexible wall 21, and a concave part 331 is formed at an end part of the at least one push rod 33; or the concave part 331 is formed on the outer side of the at least one flexible wall 21, and the convex part 211 is formed at the end part of the at least one push rod 33; and the convex part 211 is embedded in and fastened or glued to the concave part 331 to enable the moving part 32 to be connected to the flexible wall 21. The structural setting enables the push rods 33 to be more fixedly and stably connected to the inner sides of the flexible walls 21.

Preferably, the number of the push rods 33 is two, a mounting hole is formed in the moving part 32, and mounting ends of the two push rods 33 are respectively placed in and fastened or glued to the mounting holes. When one push rod 33 applies the pushing and pressing force to the inner side of one flexible wall 21, while the other push rod 33 pulls the other corresponding flexible wall 21 inwards, so the outer side of the other flexible wall 21 is in the recessed state. Steps 332 on the circumferential wall of each push rod 33 are respectively limited to end surfaces at two ends of the moving part 32.

What is claimed is:

1. A massager, comprising:
a housing internally provided with an actuation zone, two opposite side walls located at the actuation zone on the housing are respectively flexible walls; and
an actuator mounted in the actuation zone, the actuator is located between the two opposite flexible walls, and the flexible walls on the housing are driven by the actuator to move, wherein the actuator comprises a moving part and a linear motion driver, and the moving part is magnetically coupled to the linear motion driver, whereby the linear motion driver drives the moving part to make reciprocating linear motion along an actuation axis of the actuation zone, to drive the flexible walls to make reciprocating motion.

2. The massager according to claim 1, wherein the moving part is connected to or abutted against or spaced apart from the flexible walls; when the moving part is connected to the flexible walls, the moving part and the flexible walls are separate components and are fixedly connected, or are integrally formed members; when the moving part is abutted against the flexible walls, two ends of the moving part are respectively abutted against an inner side of each flexible wall; and when the moving part is spaced apart from the flexible walls, a gap between the moving part and the flexible walls is smaller than a reciprocating moving stroke of the moving part.

3. The massager according to claim 2, wherein the moving part is made of a magnetic material, and the linear motion driver comprises an insulation framework and an electromagnetic coil wound on an outer wall of the insulation framework, whereby the moving part is magnetically coupled to the linear motion driver to be driven by the linear motion driver.

4. The massager according to claim 3, wherein the insulation framework is provided with a moving channel, and the moving part is placed in the moving channel.

5. The massager according to claim 2, wherein the flexible walls have corrugated connecting walls and are arranged along the moving part as their center.

6. The massager according to claim 5, wherein a convex part is formed on an inner side of each flexible wall and is arranged at a center of the corrugated connecting wall to correspond to the moving part.

7. The massager according to claim 1, wherein at least one flexible wall is in a raised state or a flat state before not being acted upon by the moving part.

8. The massager according to claim 5, wherein a flexible sheet is arranged on an inner side of each flexible wall, an edge of the flexible sheet is at least partially connected to an inner side of a wall on the actuation zone, and the flexible sheet and the convex part are in gap fit or contact fit.

9. The massager according to claim 2, wherein when the moving part is connected to or abutted against each flexible wall, the moving part is abutted against or connected to the flexible walls through push rods, whereby the moving part acts on an inner wall of the flexible wall under the action of the push rods.

10. The massager according to claim 9, wherein a convex part is formed on an outer side of each flexible wall, and a concave part is formed at an end part of each push rod; or the concave part is formed on the outer side of each flexible wall, and the convex part is formed at the end part of each push rod; and the convex part is embedded in and fastened or glued to the concave part to enable the moving part to be connected to the flexible wall.

11. The massager according to claim 9, wherein the number of the push rods is two, a mounting hole is formed in the moving part, and mounting ends of the two push rods are respectively placed in and fastened or glued to the mounting holes.

12. The massager according to claim 8, wherein each flexible wall is provided with a hollow part, and the hollow part is arranged around the edge of the flexible wall.

13. The massager according to claim 2, wherein the housing comprises a hard shell, an accommodation cavity is formed in the hard shell, the actuation zone is a part of the accommodation cavity, a side limiting body, an upper limiting body and a lower limiting body are arranged on an inner wall of the actuation zone of the accommodation cavity, a mounting cavity is formed in the side limiting body, the linear motion driver is mounted in the mounting cavity, and the upper limiting body and the lower limiting body are respectively located at an upper port and a lower port of the mounting cavity, whereby the upper limiting body and the lower limiting body respectively limit an upper end and a lower end of the linear motion driver; and first through holes which are coaxially formed with a moving channel are respectively formed in the upper limiting body and the lower limiting body, a diameter of each first through hole is greater than or equal to that of the moving channel, two second through holes respectively corresponding to positions of the first through holes are formed in the hard shell, and the flexible walls are respectively arranged on an outer side of the hard shell to correspondingly cover positions of the two second through holes.

14. The massager according to claim 13, wherein the housing further comprises a flexible shell wrapping the outer wall of the hard shell, and the two flexible walls are formed on the flexible shell.
